(19) United States
(12) Patent Application Publication
(10) Pub. No.: US 2004/0223822 A1
(43) Pub. Date: Nov. 11, 2004

(54) Reamer and method for reaming a hole using said reamer

(76) Inventor: Albert Brosset, Vendeuvre Du Poitou (FR)

Correspondence Address: YOUNG & THOMPSON, 745 SOUTH 23RD STREET 2ND FLOOR, ARLINGTON, VA, 22202

(21) Appl. No.: 10/481,789

(22) PCT Filed: Jun. 26, 2002
(86) PCT No.: PCT/FR02/02216

(30) Foreign Application Priority Data
Jun. 26, 2001 (FR) 01/08408

(51) Int. Cl. B23B 51/00

(52) U.S. Cl. 408/158

(57) ABSTRACT

The invention relates to a reamer (20) comprising a guiding rod (22) which has a longitudinal axis of rotation and a cutting tool (30) which protrudes slightly relative to a surface of said rod (22) and is mounted between two guiding sections (24a, 24b) of the rod (22). The reamer comprises adjusting means which can displace the cutting tool (30) towards the outside of the guiding rod (22), allowing the reaming diameter to be varied in a controlled manner (22). Said reamer can be used for reaming the axis hole of a piston.

The present invention relates to a reamer and to a reaming method using said reamer.

To be more precise, the reamer is of the type including a guide rod having a longitudinal rotation axis and a cutting tool that projects slightly from the surface of said rod and is mounted between two sections of the guide rod.

The reaming method according to the invention is used in particular in the production of a bearing hole in a piston, said bearing hole being adapted to receive a gudgeon pin of a connecting rod engaged inside a cavity in said piston.

A prior art piston 10a of the above type is described next with reference to FIG. 1.

The piston 10a includes a bore 12a adapted to receive a connecting rod gudgeon pin, not shown, the connecting rod being engaged in and mobile inside a cavity 14a in the piston 10a. The bearing hole 12a passes through the piston 10a perpendicularly to the direction D of displacement of the piston 10a.

On displacement of the piston 10a, the gudgeon pin of the connecting rod, being deformed on each stroke, exerts a particularly intense stress on the points 16a of intersection of the bearing hole 12a and the cavity 14a. In the long term, this stress causes wear at said intersection points 16a, which can lead to binding of the connecting rod gudgeon pin in the piston 10a.

The present invention solves this problem.

In a first aspect, the present invention consists in a method of reaming a bearing hole passing through a piston perpendicularly to a direction of displacement of the piston, the bearing hole being adapted to receive a connecting rod gudgeon pin engaged inside a cavity in the piston. The method is characterized in that it consists in moving a cutting tool transversely during reaming to enlarge the reaming diameter of the bearing hole at the edges of the cavity to obtain a “trumpet” shaped bore.

A “trumpet” shaped bore is described later with reference to FIG. 4.

It considerably reduces the stresses exerted by the connecting rod gudgeon pin on the points of intersection of the bearing hole and the cavity in the piston during displacement of the piston.

In a second aspect, the present invention consists in a reamer including a guide rod having a longitudinal rotation axis and a cutting tool projecting slightly from a surface of the rod and mounted between two guide sections of the rod. The reamer is characterized in that it includes adjustment means adapted to move the cutting tool during reaming inward or outward relative to the guide rod to enable controlled variation of the reaming diameter during reaming.

There are undoubtedly known in the art, in particular from the documents GB-A-255 784 and U.S. Pat. No. 1,451,742, cutting tools whose radial position can be adjusted to modify the diameter of a bore, the adjustment being effected by complicated mechanisms and outside the reaming process as such, in particular when the cutting tool is withdrawn from the workpiece that is being machined. Cutting tools of the above kind cannot be used to produce a “trumpet” shaped bore.

The reamer according to the present invention is in particular perfectly adapted to the execution of a reaming method as briefly described hereinabove.

According to one particular feature, the cutting tool is fastened to a fixed flexible support by one end in a cradle of the guide rod. The flexible support includes, opposite said end, an actuation surface on which acts a lever integrated into the guide rod to cause the support to tilt.

On tilting, the cutting tool moves slightly toward the exterior of the guide rod, so that the reaming diameter can be varied, in particular at the edges of the piston cavity.

According to another particular feature, the adjustment means include a plunger forming the lever, the plunger sliding in an axial passage of the rod opening into the cradle to cooperate with the actuation surface of the support.

This embodiment is particularly advantageous because it requires a reduced number of parts.

According to another particular feature, the support includes a recess defining a bending region, the support being elastically deformable in the vicinity of the recess.

Thus the tilting support is adapted to resume a predetermined rest position when it is not subjected to the stress applied by the adjustment means. In a predetermined position, the cutting tool is flush with the surface of the guide rod, resulting in a reaming diameter corresponding to the diameter of the bearing hole bored in the piston.

According to one particular feature, the plunger has a beveled end conformed to exert a thrust on the actuation surface of the support when the plunger slides in the axial passage, the thrust leading to deformation of the support in the bending region.

The beveled shape of the end of the plunger advantageously enables very precise adjustment of the reaming diameter, in correlation with the position of the cutting tool in the bore being formed.

According to another particular feature, the reaming method includes the following steps:

reaming, to a nominal diameter d, a first section of the bearing hole to a first position of the cutting tool situated in the vicinity of the cavity;

reaming the rest of the first section with progressive augmentation of the reaming diameter by the adjustment means as far as the cavity;

crossing the cavity to position the cutting tool at the entry end of a second section of the bearing hole;

reaming the second section with progressive diminution of the reaming diameter by the adjustment means to a second position of the cutting tool in the vicinity of the cavity, the reaming diameter then returning to the nominal diameter; and

continuing reaming the second section to the nominal diameter.

Each section of the bore produced in this way is “trumpet” shaped. The progressive increase in the reaming diameter obtained by the adjustment means at the edges of the cavity significantly reduces the stresses on the connecting rod gudgeon pin at the intersection of the bearing hole and the cavity during displacement of the piston.

According to another particular feature, the method further consists in enlarging the reaming diameter at the ends of the bearing hole.

In particular, this limits the stresses exerted by the connecting rod gudgeon pin on the ends of the bearing hole in the piston.

Other aspects and advantages of the present invention will become more clearly apparent on reading the following description, which is given by way of non-limiting example only and with reference to the appended drawings, in which:

FIG. 1, already described, shows a conventional piston in cross section;

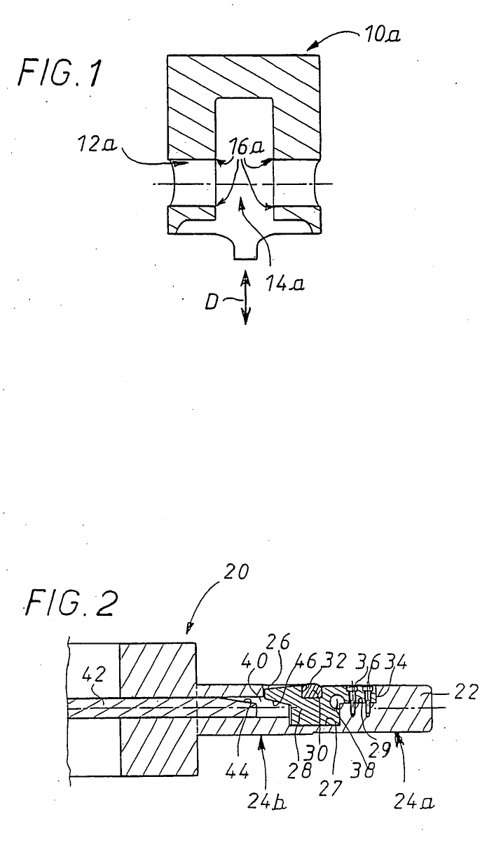

FIG. 2 shows diagrammatically in section a reamer in accordance with the invention;

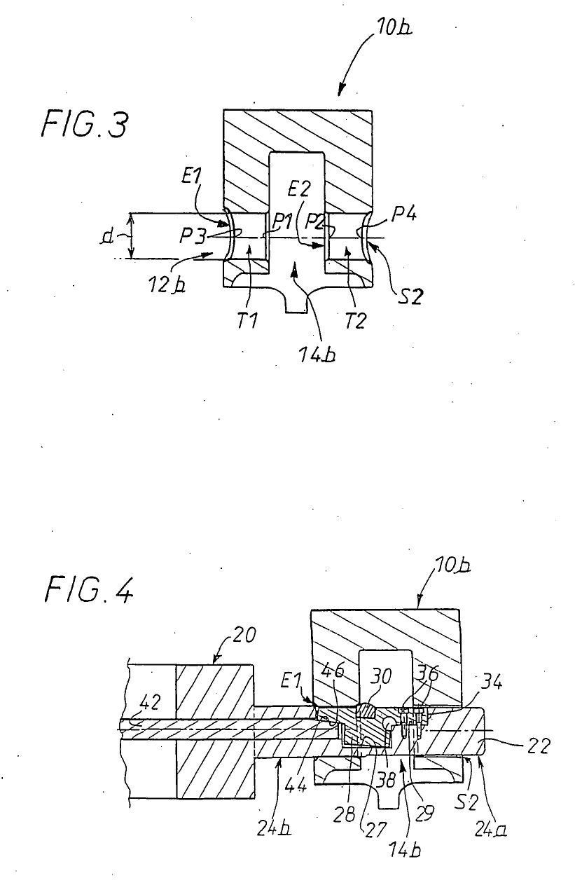

FIG. 3 shows a piston after forming a “trumpet” shaped bore in accordance with the invention;

FIG. 4 shows diagrammatically the reamer according to the invention during reaming of the bearing hole at the edges of the piston cavity; and

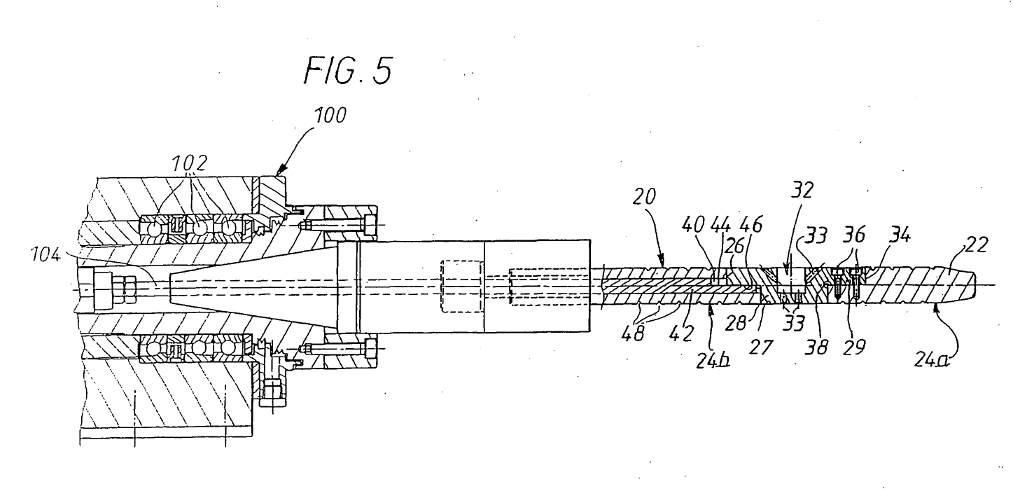

FIG. 5 shows, to scale, one embodiment of a reamer according to the invention mounted in a machine tool.

FIG. 2, described next, represents a reamer 20 according to the invention in section.

The reamer 20 is typically used to carry out a final finishing pass on a hole receiving a gudgeon pin for mounting a connecting rod in a piston.

It includes a guide rod 22 having a longitudinal rotation axis and including two guide sections 24a, 24b. The guide section 24a at the end of the rod 22 has a diameter very slightly smaller than the diameter before the reaming pass of the bearing hole bored in the piston. The second guide section 24b has a diameter slightly greater than the diameter of the first section 24a and corresponds to the final diameter, or the nominal diameter as it is otherwise known, of the bearing hole.

The guide rod 22 includes a cradle 26 adapted to receive a support 28 for a cutting tool 30, said cradle 26 being formed between the two sections 24a, 24b previously described.

The support 28 includes a location 32 for the cutting tool 30, which is held in the said location 32 by screws. FIG. 5 shows screwthreads 33 for said screws.

The cradle 26 has a hollow portion 27 for positioning a base of the support 28 and a shoulder 29 on which one end 34 of the support 28 is positioned. The end 34 of the support 28 is fixed to the guide rod 22 by screws that are screwed into screwthreads 36.

The support 28 includes a recess 38 defining a bending region in the vicinity of which the support 28 is elastically deformable. The recess 38 is opposite the shoulder 29 of the cradle 26.

When the support 28 is fixed in the cradle 26 of the guide rod 22, only the cutting tool 30 projects slightly from the guide rod 22.

The guide rod 22 includes an axial passage 40 in which slides a plunger 42 forming means for adjusting the reaming diameter.

The axial passage 40 opens into the cradle 26 of the guide rod 22.

The plunger 42 has a beveled end 44 which, when it slides in the axial passage 40 and enters the cradle 26, encounters an actuation surface 46 of the support 28. Said actuation surface 46 is defined opposite the fixing end 34 of the support 28 in the guide rod 22.

Thus the beveled end 44 of the plunger 42 forms a ramp and pushes on the support 28. The support 28 is then deformed at the recess 38 forming the bending region, which causes displacement of the cutting tool 30 toward the outside of the guide rod 22.

The plunger 42 is connected to a numerical controller, not shown here, which positions the plunger 42 very accurately in the longitudinal passage 40. It is therefore possible, by virtue of this advantageous feature, to adjust the tilting of the support 28 precisely and thereby to control the reaming diameter.

A method in accordance with the invention of reaming a bearing hole 12b in a piston lob, the bearing hole 12b being adapted to receive a connecting rod gudgeon pin, is described next with reference to FIGS. 3 and 4.

The bore to be described now is a “trumpet” shaped bore for which the reaming diameter of the bearing hole 12b is enlarged, firstly at the edges of the cavity 14b in the piston lob and secondly at the ends E1, S2 of the bearing hole 12b.

The remainder of the bearing hole 12b is reamed to a diameter d known as the nominal diameter and slightly larger than the bored diameter of the bearing hole.

Hereinafter, the bearing hole 12b is considered to consist of two sections T1, T2 on respective opposite sides of the cavity 14b in the piston lob.

The bearing hole 12b is preferably reamed symmetrically with respect to the cavity 14b.

In order to ream a significantly larger diameter at a first end E1 of the bearing hole 12b, the reaming diameter is adjusted to be significantly greater than the nominal diameter d. This adjustment is effected by the numerical controller previously cited, which is adapted to position the plunger 42 accurately in the cradle 26, which tilts the support 28 and therefore displaces the cutting tool 30 significantly outward relative to the guide rod 22.

Once the above adjustment has been established, the cutting tool 30 is positioned at the first end E1 constituting the entry end of the first section T1 of the bearing hole 12b.

The reamer 20 then enters the entry end E1 of the first section T1 at the same time as a progressive diminution of the reaming diameter is commanded. This progressive diminution is of course programmed by means of the numerical controller previously cited.

Said progressive diminution continues until the cutting tool 30 reaches a position P3 in the vicinity of the entry E1 of the first section T1, in which position P3 the reaming diameter corresponds to the nominal diameter d.

The reaming of the first section T1 then continues at the nominal diameter d to a position Pi of the cutting tool 30 situated in the vicinity of the cavity 14b, said position P1 being programmed with the aid of the numerical controller.

The remainder of the first section T1 is then reamed with a progressive augmentation of the reaming diameter as far as the cavity 14b. The diameter then obtained corresponds to the reaming diameter used at the entry end E1 of the first section T1 of the bearing hole 12b, for example. FIG. 4 shows the reamer 20 at this stage of the reaming process.

The reamer 20 then crosses the cavity 14b to a position at an entry end E2 of the second section T2 of the bearing hole 12b.

The position of the plunger 42 in the longitudinal passage 40 of the guide rod 22 does not change during this crossing.

The reaming of the second section T2 therefore begins with the reaming diameter corresponding to the end of the reaming of the first section T1.

The reamer 20 then moves forward in the second section T2, with progressive diminution of the reaming diameter, to a position P2 of the cutting tool 30 situated in the vicinity of the cavity 14b, the reaming diameter then returning to the nominal diameter d.

The reaming of the second section T2 to the nominal diameter d then continues to a position P4 of the cutting tool 30 situated in the vicinity of the second end S2, corresponding to the exit end of the bearing hole 12b.

Finally, reaming continues as far as the exit end S2 of the bearing hole 12b with progressive augmentation of the reaming diameter by the adjustment means.

The positions P1, P2, P3, P4 of the cutting tool 30 corresponding to a change of reaming diameter and the reaming diameter variations are programmed with the aid of the numerical controller. As previously specified, this programming is adapted to ream the piston 12b symmetrically with respect to the cavity 14b.

FIG. 5 shows, to scale, a reamer 20 according to the invention, the reamer 20 being mounted in a machine tool 100.

The cutting tool 30 is not shown in the figure. Helicoidal passages 48 that supply lubricating oil during reaming are shown, however.

Said machine tool 100 includes a motor adapted to drive rotation of the reamer 20 in ball bearings 102.

It further includes a shaft 104 adapted to position the plunger 42 in the axial passage 40. Said shaft 104 is driven by the numerical controller previously cited.

1. A reamer (20) including a guide rod (22) having a longitudinal rotation axis and a cutting tool (30) projecting slightly from a surface of said rod (22) and mounted between two guide sections (24a, 24b) of said rod (22), characterized in that it includes adjustment means adapted to move said cutting tool (30) during reaming inward or outward relative to said guide rod (22) to enable controlled variation of the reaming diameter during reaming.

2. A reamer (20) according to claim 1, characterized in that said cutting tool (30) is fastened to a fixed flexible support (28) by one end (34) in a cradle (26) of said guide rod (22), said flexible support (28) including, opposite said end, an actuation surface (46) on which acts a lever integrated into said guide rod (22) to cause said support (28) to tilt.

3. A reamer (20) according to claim 2, characterized in that said adjustment means include a plunger (42) forming said lever, said plunger (42) sliding in an axial passage (40) of said rod (22) opening into said cradle (26) to cooperate with said actuation surface (46).

4. A reamer (20) according to claim 2, characterized in that said support (28) includes a recess (38) defining a bending region, said support (28) being elastically deformable in the vicinity of said recess (38).

5. A reamer (20) according to claim 3, characterized in that said plunger (42) has a beveled end (44) conformed to exert a thrust on said actuation surface (46) of said support (28) when said plunger (42) slides in said axial passage (40), said thrust leading to deformation of said support (28) in said bending region (38).

6. A method of reaming a bearing hole (12b) passing through a piston (10b) perpendicularly to a direction of displacement of said piston (10b), said bearing hole (12b) being adapted to receive a connecting rod gudgeon pin engaged inside a cavity (14b) in said piston (10b), said method being characterized in that it consists in moving a cutting tool (30) transversely during reaming to enlarge the reaming diameter of said bearing hole (12b) at the edges of said cavity (14b) to obtain a “trumpet” shaped bore.

7. A reaming method according to claim 6, characterized in that, the reaming being carried out by a reamer (20) including a guide rod (22) having a longitudinal rotation axis and a cutting tool (30) projecting slightly from a surface of said rod (22) and mounted between two guide sections (24a, 24b) of said rod (22), said reamer (20) including adjustment means adapted to move during reaming said cutting tool (30) inward or outward relative to said guide rod (22) to enable controlled variation of the reaming diameter, the reaming method includes the following steps:
reaming, to a nominal diameter (d), a first section (T1) of said bearing hole (12b) to a first position (P1) of said cutting tool (30) situated in the vicinity of said cavity (14b);
reaming the rest of said first section (T1) with progressive augmentation of the reaming diameter by said adjustment means as far as said cavity (14b);
crossing said cavity (14b) to position said cutting tool (30) at the entry end (E2) of a second section (T2) of said bearing hole (12b);
reaming said second section (T2) with progressive diminution of the reaming diameter by said adjustment means to a second position (P2) of said cutting tool in the vicinity of said cavity (14b), said reaming diameter then returning to said nominal diameter (d); and
continuing reaming said second section (T2) to said nominal diameter (d).

8. A reaming method according to claim 6, characterized in that it further consists in enlarging the reaming diameter at the ends (El, S2) of said bearing hole (12b).

9. A reaming method according to claim 8, characterized in that, the reaming being carried out by a reamer (20) including a guide rod (22) having a longitudinal rotation axis and a cutting tool (30) projecting slightly from a surface of said rod (22) and mounted between two guide sections (24a, 24b) of said rod (22), said reamer including adjustment means adapted to move during reaming said cutting tool (30) outward relative to said rod (22) to enable controlled variation of the reaming diameter, the reaming method includes the following steps:
adjusting the reaming diameter to a diameter significantly greater than a nominal diameter (d) and positioning said cutting tool (30) at the entry end (E1) of a first section (T1) of said bearing hole (12b);
reaming said first section (T1) with progressive diminution of the reaming diameter by said adjustment means to a third position (P3) of said cutting tool (30) in the vicinity of said entry end (E1) of said first section (T1), said reaming diameter then corresponding to said nominal diameter (d);
reaming said first section (T1) to said nominal diameter (d) to a first position (P1) of said cutting tool (30) in the vicinity of said cavity (14b);
reaming the rest of said first section (T1) as far as said cavity (14b) with progressive augmentation of the reaming diameter by said adjustment means;
crossing said cavity (14b) to position said cutting tool (30) at the entry end (E2) of the second section (T2) of said bearing hole (12b);
reaming said second section (T2) with progressive diminution of the reaming diameter by said adjustment means to a second position (P2) of said cutting tool (30) in the vicinity of said cavity (14b), said reaming diameter then returning to said nominal diameter (d);
reaming said second section (T2) to said nominal diameter (d) to a fourth position (P4) of said cutting tool (30) in the vicinity of an exit end (S2) of said second section (T2); and
continuing reaming to said exit end (S2) with progressive augmentation of the reaming diameter by said adjustment means.

10. A reamer (20) according to claim 3, characterized in that said support (28) includes a recess (38) defining a bending region, said support (28) being elastically deformable in the vicinity of said recess (38).

11. A reamer (20) according to claim 4, characterized in that said plunger (42) has a beveled end (44) conformed to exert a thrust on said actuation surface (46) of said support (28) when said plunger (42) slides in said axial passage (40), said thrust leading to deformation of said support (28) in said bending region (38).
